(19) United States
(12) Patent Application Publication
(10) Pub. No.: US 2025/0317374 A1
(43) Pub. Date: Oct. 9, 2025

(54) COMMUNICATION APPARATUS, COMMUNICATION SYSTEM, NOTIFICATION METHOD, CONTROL METHOD AND PROGRAM

(71) Applicant: NIPPON TELEGRAPH AND TELEPHONE CORPORATION, Tokyo (JP)

(72) Inventors: Yushi KOYASAKO, Musashino-shi, Tokyo (JP); Takashi YAMADA, Musashino-shi, Tokyo (JP); Tomoya HATANO, Musashino-shi, Tokyo (JP)

(73) Assignee: NIPPON TELEGRAPH AND TELEPHONE CORPORATION, Tokyo (JP)

(21) Appl. No.: 18/866,944

(22) PCT Filed: May 31, 2022
(86) PCT No.: PCT/JP2022/022117

§ 371 Date: Nov. 18, 2024

(51) Int. Cl. H04L 43/0852; H04L 49/253

(52) U.S. Cl. CPC H04L 43/0852; H04L 49/253

(57) ABSTRACT

A base station device includes: a delay notification unit that, before a communication path to user equipment is switched, executes processing of issuing information of the switched communication path or delay information of the communication path and information regarding a switching time of the communication path; and a handover execution unit that requests a predetermined switching device to switch the communication path at the switching time. A collection device includes: a delay collection unit that, before a communication path to user equipment is switched, collects information of the switched communication path or delay information of the communication path and information regarding a switching time of the communication path; and a control unit that, after the switching time, controls the user equipment by using the delay information associated with the issued information of the communication path or the issued delay information.

### TECHNICAL FIELD

The present invention relates to a communication device, a communication system, a notification method, a control method, and a program.

### BACKGROUND ART

User equipment (UE) (e.g. a drone) wirelessly communicates with a base station device while moving under the control of a control unit (control application). The control unit that has received an instruction from the user equipment remotely controls the user equipment on the basis of information of the user equipment itself and delay information of a communication path to the user equipment. Here, a handover from a source base station device to a destination base station device may be executed according to movement of the user equipment (see Non Patent Literature 1).

### CITATION LIST

### Non Patent Literature

Non Patent Literature 1: 3GPP TS 36.300, V10.11.0, 2013-09.

### SUMMARY OF INVENTION

### Technical Problem

In a case where a handover from a source base station device to a destination base station device is executed, a communication path to user equipment is switched. Further, delay information of the communication path is changed in response to the switching of the communication path. Here, in a case where, although the communication path is switched, the user equipment is controlled by using the delay information before the communication path is switched (old delay information), control performance of the user equipment deteriorates because the old delay information used for the control is different from delay information of an actual communication path.

In view of the above circumstances, an object of the present invention is to provide a communication device, a communication system, a notification method, a control method, and a program capable of suppressing deterioration of control performance of user equipment that wirelessly communicates with a base station device even in a case where a communication path to the user equipment is switched.

### Solution to Problem

An aspect of the present invention is a communication device including: a delay notification unit that, before a communication path to user equipment is switched, executes processing of issuing information of the switched communication path or delay information of the communication path and information regarding a switching time of the communication path; and a handover execution unit that requests a predetermined switching device to switch the communication path at the switching time.

An aspect of the present invention is a communication device including: a delay collection unit that, before a communication path to user equipment is switched, collects information of the switched communication path or delay information of the communication path and information regarding a switching time of the communication path; and a control unit that, after the switching time, controls the user equipment by using the delay information associated with the issued information of the communication path or the issued delay information.

An aspect of the present invention is a communication system including: a delay notification unit that, before a communication path to user equipment is switched, executes processing of issuing information of the switched communication path or delay information of the communication path and information regarding a switching time of the communication path; a handover execution unit that requests a predetermined switching device to switch the communication path at the switching time; a delay collection unit that, before the communication path to the user equipment is switched, collects the information of the switched communication path or the delay information of the communication path and the information regarding the switching time of the communication path; and a control unit that, after the switching time, controls the user equipment by using the delay information associated with the issued information of the communication path or the issued delay information.

An aspect of the present invention is a notification method executed by a communication device, the notification method including: a step of, before a communication path to user equipment is switched, executing processing of issuing information of the switched communication path or delay information of the communication path and information regarding a switching time of the communication path; and a step of requesting a predetermined switching device to switch the communication path at the switching time.

An aspect of the present invention is a control method executed by a communication device, the control method including: a step of, before a communication path to user equipment is switched, collecting information of the switched communication path or delay information of the communication path and information regarding a switching time of the communication path; and a step of, after the switching time, controlling the user equipment by using the delay information associated with the issued information of the communication path or the issued delay information.

An aspect of the present invention is a program for causing a computer to execute: a procedure of, before a communication path to user equipment is switched, executing processing of issuing information of the switched communication path or delay information of the communication path and information regarding a switching time of the communication path; and a procedure of requesting a predetermined switching device to switch the communication path at the switching time.

An aspect of the present invention is a program for causing a computer to execute: a procedure of, before a communication path to user equipment is switched, collecting information of the switched communication path or delay information of the communication path and information regarding a switching time of the communication path; and a procedure of, after the switching time, controlling the user equipment by using the delay information associated with the issued information of the communication path or the issued delay information.

### Advantageous Effects of Invention

The present invention can suppress deterioration of control performance of user equipment that wirelessly communicates with a base station device even in a case where a communication path to the user equipment is switched.

### BRIEF DESCRIPTION OF DRAWINGS

FIG. 1 illustrates a configuration example of a communication system in a first embodiment.

FIG. 2 illustrates a configuration example of a base station device in the first embodiment.

FIG. 3 is a sequence diagram showing an operation example of the communication system in the first embodiment.

FIG. 4 illustrates a configuration example of a communication system in a modification example of the first embodiment.

FIG. 5 illustrates a configuration example of a communication system in a second embodiment.

FIG. 6 is a sequence diagram showing an operation example of the communication system in the second embodiment.

FIG. 7 illustrates a configuration example of a communication system in a third embodiment.

FIG. 8 illustrates a configuration example of a base station device in the third embodiment.

FIG. 9 is a sequence diagram showing an operation example of the communication system in the third embodiment.

FIG. 10 illustrates a configuration example of a communication system in a fourth embodiment.

FIG. 11 illustrates a configuration example of a base station device in the fourth embodiment.

FIG. 12 is a sequence diagram showing an operation example of the communication system in the fourth embodiment.

FIG. 13 illustrates a hardware configuration example of a communication device in each embodiment.

### DESCRIPTION OF EMBODIMENTS

Embodiments of the present invention will be described in detail with reference to the drawings.

### First Embodiment

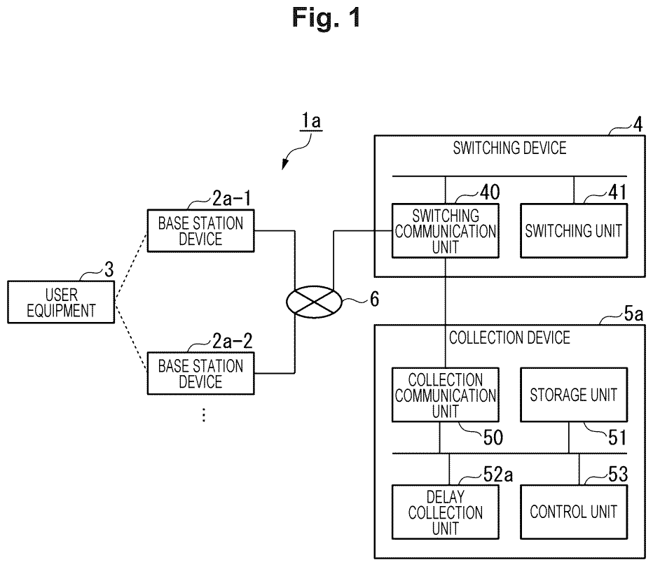

FIG. 1 illustrates a configuration example of a communication system 1a in a first embodiment. The communication system 1a executes wireless communication. The communication system 1a includes a plurality of base station devices 2a, user equipment 3, a switching device 4, a collection device 5a, and a communication line 6. Hereinafter, a target to be controlled by using wireless communication (wireless section) is the user equipment 3.

A time of the base station device 2a and a time of the collection device 5a are synchronized by using, for example, a network time protocol. The time of the base station device 2a and the time of the collection device 5a may be synchronized by using, for example, a positioning signal from an artificial satellite. The positioning signal is, for example, a global positioning system (GPS) signal.

The switching device 4 includes a switching communication unit 40 and a switching unit 41. The collection device 5a includes a collection communication unit 50, a storage unit 51, a delay collection unit 52a, and a control unit 53. The control unit 53 may be provided in an edge server (not illustrated) belonging to the collection device 5a.

The base station device 2a is a wireless base station device and is, for example, the eNodeB (evolved Node B). In the plurality of base station devices 2a, a source base station device 2a (base station device 2a-1) and a destination base station device 2a (base station device 2a-2) are determined according to movement (position) of the user equipment 3.

The source base station device 2a-1 wirelessly communicates with the user equipment 3. The source base station device 2a-1 instructs the user equipment 3 to measure power of a wireless signal for one or more base station devices 2a around the user equipment 3. The source base station device 2a-1 acquires a measurement result of the power of the wireless signal from the user equipment 3.

The source base station device 2a-1 outputs a handover execution request to the destination base station device 2a-2 according to the movement (position) of the user equipment 3. That is, the source base station device 2a-1 selects the destination base station device 2a-2 on the basis of the measurement result of the power of the wireless signal. The source base station device 2a-1 outputs the handover execution request to the destination base station device 2a-2. The base station device 2a-1 outputs a handover execution instruction to the user equipment 3. Therefore, a handover from the source base station device 2a to the destination base station device 2a is executed according to the movement of the user equipment 3.

In a case where the handover is executed, a communication path to the user equipment 3 is switched, and thus the base station device 2a-1 or the base station device 2a-2 changes delay information of the communication path in response to the switching of the communication path to the user equipment 3. The delay information varies depending on, for example, a length of the communication path. The communication path is, for example, a communication path from the collection device 5a (control device) to the user equipment 3.

In the first embodiment, the destination base station device 2a-2 notifies the collection device 5a of occurrence of switching of the communication path by a push notification method. Here, the base station device 2a-2 notifies the collection device 5a of the delay information of the switched communication path. Before the communication path to the user equipment 3 is switched, the base station device 2a-2 notifies the collection device 5a of the delay information of the switched communication path and information regarding a switching time (switching timing) of the communication path.

The base station device 2a-2 requests the switching device 4 to switch the communication path at the switching time. The base station device 2a-2 executes communication path switching processing under the control of the switching device 4.

The user equipment 3 (mobile terminal) is a communication device to be controlled by a user and is, for example, a drone or an IoT (Internet of Things) terminal. The user controls the user equipment 3 by giving an instruction to the control unit 53. The user equipment 3 moves under the control of the control unit 53.

The user equipment 3 acquires a signal to request measurement of power (signal strength) of a wireless signal from the source base station device 2a-1. When acquiring the signal to request measurement of power of a wireless signal, the user equipment 3 measures power of a wireless signal for one or more base station devices 2a around the user equipment 3. The user equipment 3 transmits a measurement result of the power of the wireless signal to the source base station device 2a-1.

The switching device 4 (host node) is a device (network node) which switches the communication path and is, for example, a mobility management entity (MME) or a serving gateway (S-GW). In the first embodiment, the switching device 4 acquires a communication path switching request from the destination base station device 2a-2. In response to the communication path switching request, the switching device 4 outputs a communication path switching instruction to the destination base station device 2a-2.

The switching communication unit 40 communicates with each base station device 2a via the communication line 6. The switching communication unit 40 transfers a signal received from the base station device 2a to the switching unit 41. The switching communication unit 40 transfers a signal output from the switching unit 41 to the base station device 2a serving as a destination of the signal.

The switching communication unit 40 communicates with the collection communication unit 50. The switching communication unit 40 transfers a signal received from the collection communication unit 50 to the base station device 2a that wirelessly communicates with the user equipment 3 serving as a destination of the signal.

The switching unit 41 acquires a communication path switching request from the destination base station device 28-2. In response to the communication path switching request, the switching unit 41 outputs a communication path switching instruction to, for example, the destination base station device 2a-2.

The collection device 5a is managed by, for example, a communication carrier. The collection device 5a collects predetermined information from the base station device 2a. For example, the collection device 5a collects the delay information of the communication path and the information regarding the switching time from one or more base station devices 2a. In the first embodiment, the collection device 5a collects the delay information of the communication path and the information regarding the switching time from the destination base station device 2a-2. The collection device 5a remotely controls the user equipment 3 on the basis of predetermined information of the user equipment 3 itself and the delay information of the communication path to the user equipment 3.

The collection communication unit 50 communicates with the switching communication unit 40. Here, the collection communication unit 50 communicates with the user equipment 3 via the switching communication unit 40, the communication line 6, and the base station device 2a. The storage unit 51 stores, for example, information of the user equipment itself (e.g. identification information), the delay information of the communication path to the user equipment, and the information regarding the switching time of the communication path as a delay information database.

The delay collection unit 52a (collection application) collects the information of the user equipment itself, the delay information of the communication path to the user equipment, and the information regarding the switching time of the communication path from the destination base station device 2a via the collection communication unit 50.

The control unit 53 (control application) controls the user equipment 3 via the collection communication unit 50, the switching communication unit 40, the communication line 6, and the base station device 2a. Here, the control unit 53 controls the user equipment 3 by using issued delay information (new delay information) after the switching time.

Next, the base station device 2a will be described.

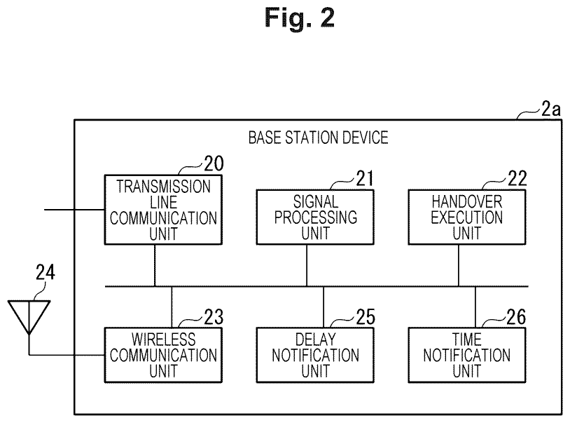

FIG. 2 illustrates a configuration example of the base station device 2a in the first embodiment. The base station device 2a includes a transmission line communication unit 20, a signal processing unit 21, a handover execution unit 22, a wireless communication unit 23, an antenna 24, a delay notification unit 25, and a time notification unit 26.

The transmission line communication unit 20 (transmission line interface) communicates with the switching communication unit 40 via the communication line 6. The transmission line communication unit 20 communicates with the collection communication unit 50 via the communication line 6 and the switching communication unit 40.

The signal processing unit 21 executes predetermined first baseband signal processing with respect to an electrical signal output from the transmission line communication unit 20. The signal processing unit 21 outputs the electrical signal (baseband signal) to the antenna 24 according to an execution result of the predetermined first baseband signal processing. The signal processing unit 21 executes predetermined second baseband signal processing with respect to an electrical signal output from the antenna 24. The signal processing unit 21 outputs the electrical signal to the transmission line communication unit 20 according to an execution result of the predetermined second baseband signal processing.

The handover execution unit 22 of the source base station device 2a-1 acquires a measurement result of power of a wireless signal from the user equipment 3 via the antenna 24 and the wireless communication unit 23. The handover execution unit 22 selects the destination base station device 2a-2 from among the base station devices 2a on the basis of the measurement result of the power of the wireless signal. The handover execution unit 22 of the source base station device 2a-1 outputs a handover execution request to the destination base station device 2a-2 via the transmission line communication unit 20 on the basis of the measurement result of the power of the wireless signal. The handover execution unit 22 of the source base station device 2a-1 outputs a handover execution instruction to the user equipment 3 via the wireless communication unit 23 and the antenna 24 on the basis of the measurement result of the power of the wireless signal.

The handover execution unit 22 of the destination base station device 2a-2 executes synchronization processing with the user equipment 3. The handover execution unit 22 transmits a communication path switching request to the switching device 4. The handover execution unit 22 switches the communication path in response to a switching instruction acquired from the switching device 4.

The wireless communication unit 23 outputs an electrical signal (baseband signal) output from the signal processing unit 21 to the antenna 24. The wireless communication unit 23 outputs a baseband signal corresponding to an electrical signal output from the antenna 24 to the signal processing unit 21.

The antenna 24 transmits and receives a wireless signal between the antenna 24 and the user equipment 3. For example, the antenna 24 transmits a wireless signal corresponding to an electrical signal output from the wireless communication unit 23 to the user equipment 3. For example, the antenna 24 transmits an electrical signal corresponding to a wireless signal received from the user equipment 3 to the wireless communication unit 23.

The delay notification unit 25 (switching notification unit) of the destination base station device 2a-2 changes the delay information of the communication path in response to the switching of the communication path to the user equipment 3. The delay notification unit 25 notifies the collection communication unit 50 of the delay information of the switched communication path (delay information of the changed communication path) via the transmission line communication unit 20 by the push notification method.

The time notification unit 26 of the destination base station device 2a-2 changes the information regarding the switching time of the communication path in response to the switching of the communication path to the user equipment 3. The time notification unit 26 notifies the collection communication unit 50 of the information regarding the switching time of the communication path via the transmission line communication unit 20 by the push notification method.

Next, an operation example of the communication system 1a will be described.

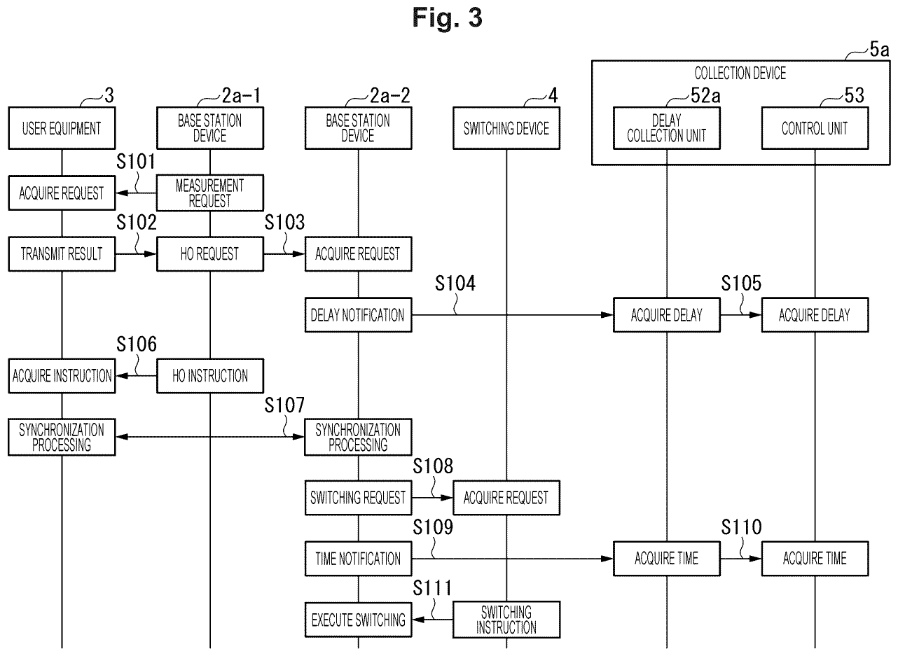

FIG. 3 is a sequence diagram showing the operation example of the communication system 1a in the first embodiment. The base station device 2a-1 transmits a signal to request measurement of power (signal strength) of a wireless signal to the user equipment 3. The user equipment 3 acquires the signal to request measurement of power of a wireless signal from the base station device 2a-1 (step S101). The user equipment 3 transmits a measurement result of the power of the wireless signal to the source base station device 2a-1 (step S102).

The source base station device 2a-1 outputs a handover execution request to the destination base station device 2a-2 on the basis of the measurement result of the power of the wireless signal. The base station device 2a-2 acquires the handover execution request (HO request) from the base station device 2a-1 (step S103).

The base station device 2a-2 changes delay information of a communication path to the user equipment 3 in response to switching of the communication path. The base station device 2a-2 (first communication device) transmits the delay information of the switched communication path (delay information of the changed communication path) to the delay collection unit 52a of the collection device 5a (second communication device). The delay collection unit 52a acquires the delay information of the switched communication path from the base station device 2a-2 (step S104). The delay collection unit 52a notifies the control unit 53 of the delay information of the changed communication path by using an API (application programming interface). The control unit 53 acquires the delay information of the switched communication path from the delay collection unit 52a (step S105).

The base station device 2a-1 outputs a handover execution instruction (HO instruction) to the user equipment 3. The user equipment 3 acquires the handover execution instruction from the base station device 2a-1 (step S106). The user equipment 3 and the base station device 2a-2 execute synchronization processing (step S107),

The base station device 2a-2 transmits a communication path switching request to the switching device 4. The switching device 4 acquires the Communication path switching request from the destination base station device 2a-2 (step S108). The base station device 2a-2 notifies the delay collection unit 52a of information regarding a switching time of the communication path. The delay collection unit 52a acquires the information regarding the switching time of the communication path from the base station device 2a-2 (step S109).

The delay collection unit 52a notifies the control unit 53 of the information regarding the switching time of the communication path by using the API. The control unit 53 acquires the information regarding the switching time of the communication path from the delay collection unit 52a (step S110). In response to the communication path switching request, the switching device 4 outputs a communication path switching instruction to the destination base station device 2a-2. The destination base station device 2a-2 switches the communication path (step S111).

Note that, in a case where the delay collection unit 52a has a high processing speed, the notification of the delay information (notification of path switching) in step S104 and the notification of the information regarding the switching time of the communication path in step S110 may be simultaneously executed.

As described above, before the communication path to the user equipment 3 is switched, the delay notification unit 25 executes processing of issuing the delay information of the switched communication path and the information regarding the switching time of the communication path. The handover execution unit 22 requests the predetermined switching device 4 to switch the communication path at the switching time of the communication path. The delay collection unit 52a collects the issued delay information and information regarding the switching time. The control unit 53 (control application) controls the user equipment 3 by using the issued delay information (new delay information) after the switching time.

As described above, the user equipment is controlled by using the delay information accurately changed according to the communication path after the switching time of the communication path. Therefore, even in a case where the communication path to the user equipment that wirelessly communicates with the base station device is switched, it is possible to suppress deterioration of control performance of the user equipment.

### First Modification Example of First Embodiment

A first modification example of the first embodiment is different from the first embodiment in that the communication system includes a core network between the switching device and the collection device. In the first modification example of the first embodiment, the difference from the first embodiment will be mainly described.

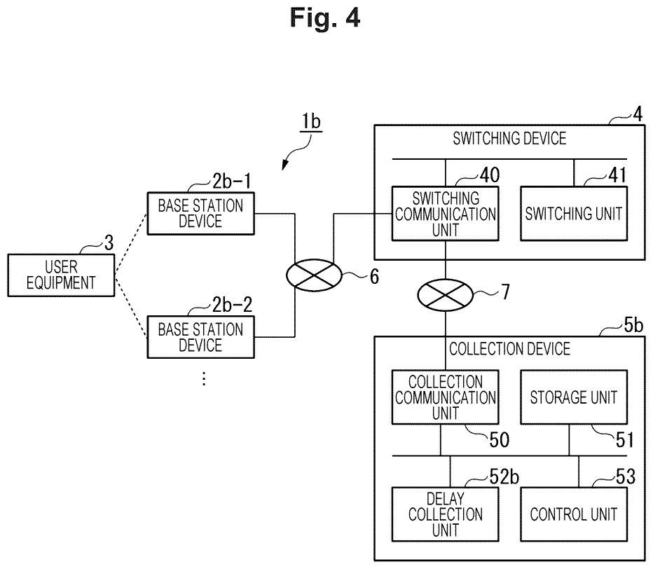

FIG. 4 illustrates a configuration example of a communication system 1b in the first modification example of the first embodiment. The communication system 1b includes a plurality of base station devices 2b, the user equipment 3, the switching device 4, a collection device 5b, the communication line 6, and a core network 7. The core network 7 includes, for example, one or more switches (not illustrated). The collection communication unit 50 communicates with the switching communication unit 40 via the core network 7.

As described above, the communication system 1b includes the core network 7 between the switching device 4 and the collection device 5b. Therefore, even in a case where the communication path to the user equipment that wirelessly communicates with the base station device is switched, it is possible to suppress deterioration of the control performance of the user equipment by using the core network from a remote location of the user equipment 3.

### Second Modification Example of First Embodiment

A second modification example of the first embodiment is different from the first embodiment in that the base station device 2a does not need to notify (delay notification) the collection device 5a of the delay information of the switched communication path. In the second modification example of the first embodiment, the difference from the first embodiment will be mainly described.

It is assumed that a period of time from the time at which the information regarding the switching time is issued (step S110 in FIG. 3) to the time at which the communication path is switched (step S111 in FIG. 3) is extremely short.

Therefore, in step S104 of FIG. 3, the base station device 2a-2 notifies the collection device 5a of communication path switching information (information regarding the switched communication path) in advance. Here, because the storage unit 51 stores the delay information database (database including the delay information of the communication path) in advance, the communication path switching information only needs to include the information regarding the switched communication path and does not need to include the delay information of the switched communication path.

In step S105 of FIG. 3, the control unit 53 acquires the communication path switching information, The control unit 53 starts a sequence for preparing in advance for switching of the communication path. Based on the switching information issued in advance in step S105 of FIG. 3, the control unit 53 switches a reference part in the delay information database to the delay information of the switched communication path at the issued switching time (time in step S111 of FIG. 3).

As described above, the base station device 2a-2 notifies the collection device 5a of the information regarding the switched communication path in advance. The base station device 2a-2 notifies the collection device 5a of the information regarding the switching time. Based on the information regarding the communication path issued in advance, the control unit 53 switches the reference part in the delay information database to the delay information of the switched communication path.

That is, before the communication path to the user equipment 3 is switched, the delay notification unit 25 executes processing of issuing the information regarding the switched communication path and the information regarding the switching time of the communication path. The handover execution unit 22 requests the predetermined switching device 4 to switch the communication path at the switching time of the communication path. The delay collection unit 52a collects delay information associated with the issued information regarding the communication path from the delay information database. The delay collection unit 52a collects the information regarding the switching time from the delay collection unit 52a. The control unit 53 (control application) controls the user equipment 3 by using the delay information (new delay information) of the communication path associated with the issued information regarding the communication path after the switching time.

Therefore, in a case where the communication path to the user equipment 3 that wirelessly communicates with the base station device 2a is switched, it is possible to suppress deterioration of the control performance of the user equipment 3 on the basis of the delay information database of the storage unit 51 even when the delay information of the communication path is not issued from the base station device 2a or the delay collection unit 52a to the control unit 53.

### Second Embodiment

A second embodiment is mainly different from the first embodiment in that a source base station device notifies a collection device of occurrence of switching of a communication path (handover). In the second embodiment, the difference from the first embodiment will be mainly described,

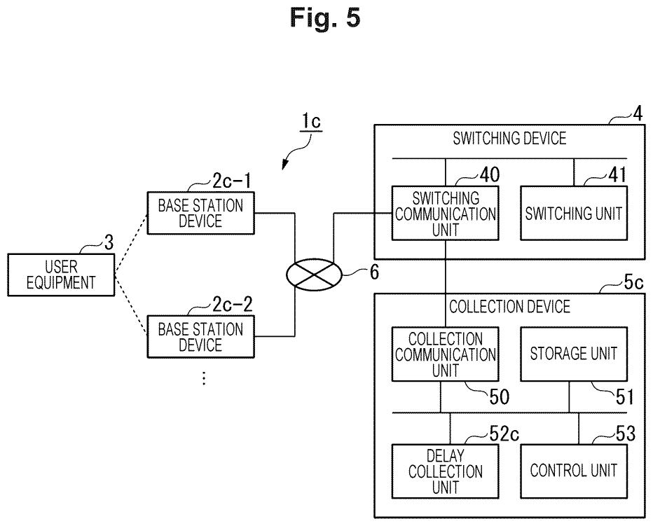

FIG. 5 illustrates a configuration example of a communication system 1c in the second embodiment. The communication system 1c includes a plurality of base station devices 2c, user equipment 3, a switching device 4, a collection device 5c, and a communication line 6. The switching device 4 includes a switching communication unit 40 and a switching unit 41. The collection device 5c includes a collection communication unit 50, a storage unit 51, a delay collection unit 52c, and a control unit 53. In the second embodiment, a source base station device 2c-1 notifies the collection device 5c of occurrence of switching of the communication path by the push notification method.

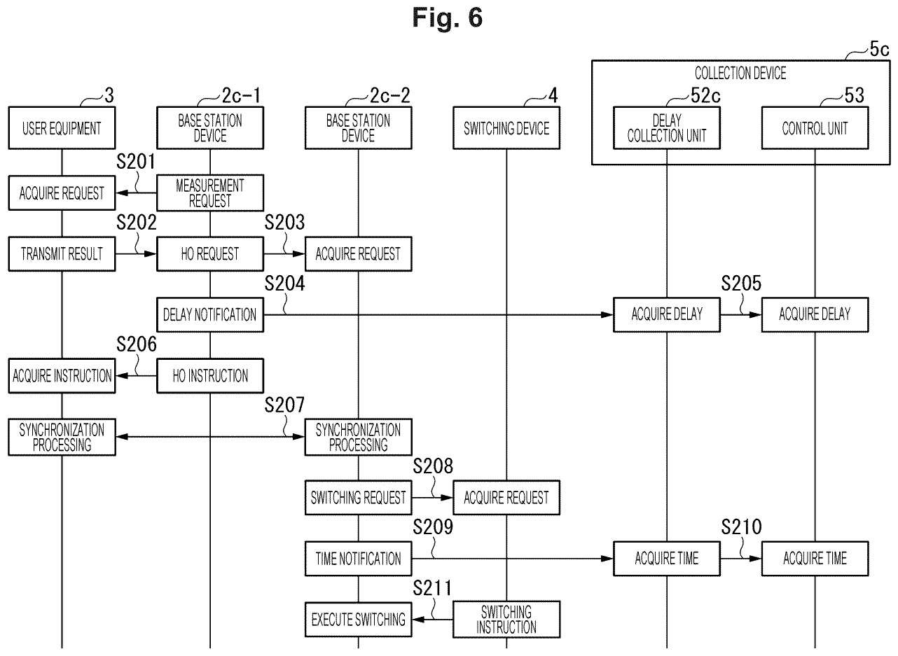

FIG. 6 is a sequence diagram showing an operation example of the communication system 1c in the second embodiment. Step S201 to step S203 are similar to step S101 to step S103 in FIG. 3.

The base station device 2c-1 changes delay information of a communication path to the user equipment 3 in response to switching of the communication path. The base station device 2c-1 notifies the delay collection unit 52c of the delay information of the switched communication path. The delay collection unit 52c acquires the delay information of the switched communication path from the base station device 2c-1 (step S204). Step S205 to step S211 are similar to step S105 to step S111 in FIG. 3.

As described above, the source base station device 2c-1 transmits the delay information of the switched communication path to the delay collection unit 52c. Therefore, even in a case where the communication path to the user equipment that wirelessly communicates with the base station device is switched, it is possible to suppress deterioration of the control performance of the user equipment.

### Third Embodiment

A third embodiment is mainly different from the first and second embodiments in that a notification method of a base station device to a collection device is a pull notification method. In the third embodiment, the difference from the first and second embodiments will be mainly described.

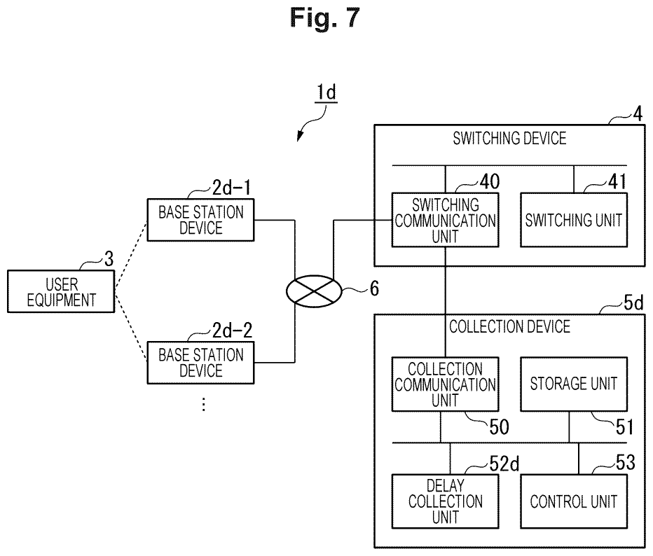

FIG. 7 illustrates a configuration example of a communication system 1d in the third embodiment, The communication system 1d includes a plurality of base station devices 2d, user equipment 3, a switching device 4, a collection device 5d, and a communication line 6. The switching device 4 includes a switching communication unit 40 and a switching unit 41. The collection device 5d includes a collection communication unit 50, a storage unit 51, a delay collection unit 52d, and a control unit 53.

In the third embodiment, a method in which the base station device 2d notifies the collection device 5d of switching of a communication path is a pull notification method. The delay collection unit 52d transmits a signal to request notification of delay information of the switched communication path (handover monitoring packet) to a destination base station device 2d-2 at a predetermined cycle. The delay collection unit 52d may transmit a signal to request notification of delay information of the switched communication path to a plurality of possible destination base station devices 2d at a predetermined cycle.

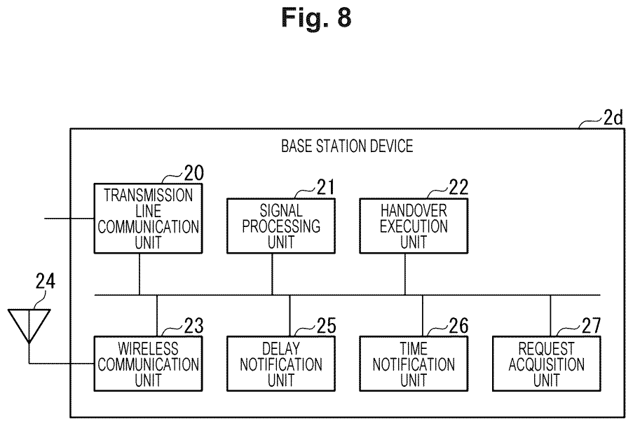

FIG. 8 illustrates a configuration example of the base station device 2d in the third embodiment. The base station device 2d includes a transmission line communication unit 20, a signal processing unit 21, a handover execution unit 22, a wireless communication unit 23, an antenna 24, a delay notification unit 25, a time notification unit 26, and a request acquisition unit 27.

The request acquisition unit 27 of the destination base station device 2d-2 acquires, from the delay collection unit 52d, the signal to request the notification of the delay information of the switched communication path. In a case where the signal to request the notification of the delay information of the switched communication path is acquired, the delay notification unit 25 transmits the delay information of the switched communication path to the delay collection unit 52d every time the signal is acquired.

Next, an operation example of the communication system 1d will be described.

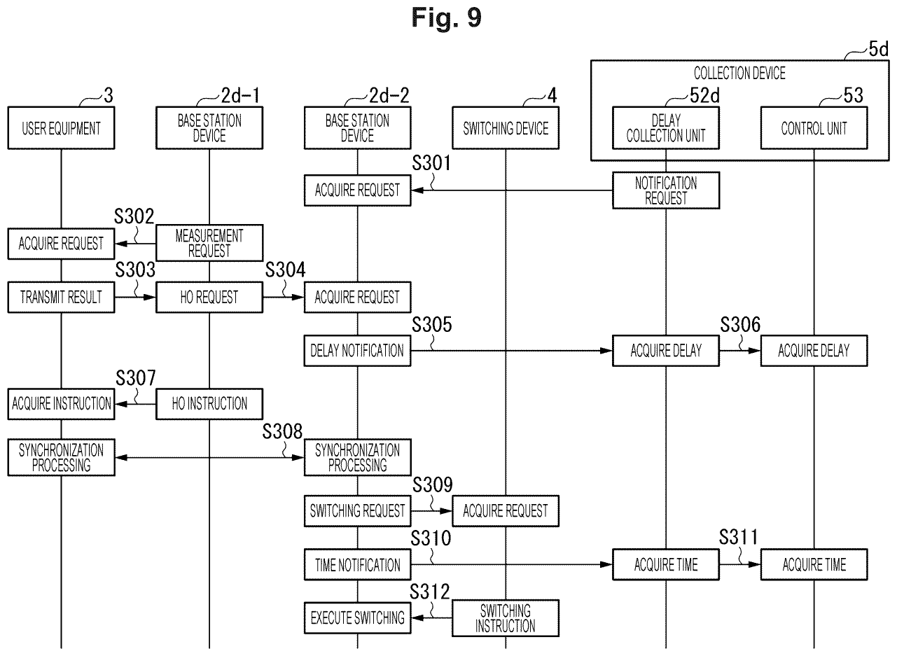

FIG. 9 is a sequence diagram showing the operation example of the communication system 1d in the third embodiment, The delay collection unit 52d transmits a signal to request notification of delay information of a switched communication path to the destination base station device 2d-2 at a predetermined cycle. The base station device 2d-2 acquires the signal transmitted from the delay collection unit 52d at the predetermined cycle from the delay collection unit 52d (step S301).

Step S302 to step S304 are similar to step S101 to step S103 in FIG. 3. In a case where the signal to request the notification of the delay information of the switched communication path is acquired, the delay notification unit 25 transmits the delay information of the switched communication path to the delay collection unit 52d. The delay collection unit 52d acquires the delay information of the switched communication path from the delay notification unit 25 (step S305). Step S306 to step S312 are similar to step S105 to step S111 in FIG. 3.

As described above, in a case where the signal to request the notification of the delay information of the switched communication path is acquired, the delay notification unit 25 transmits the delay information of the switched communication path to the delay collection unit 52d. Therefore, even in a case where the communication path to the user equipment that wirelessly communicates with the base station device is switched, it is possible to suppress deterioration of the control performance of the user equipment.

### Fourth Embodiment

A fourth embodiment is mainly different from the third embodiment in that a source base station device requests a destination base station device to notify a collection device of delay information. In the fourth embodiment, the difference from the third embodiment will be mainly described.

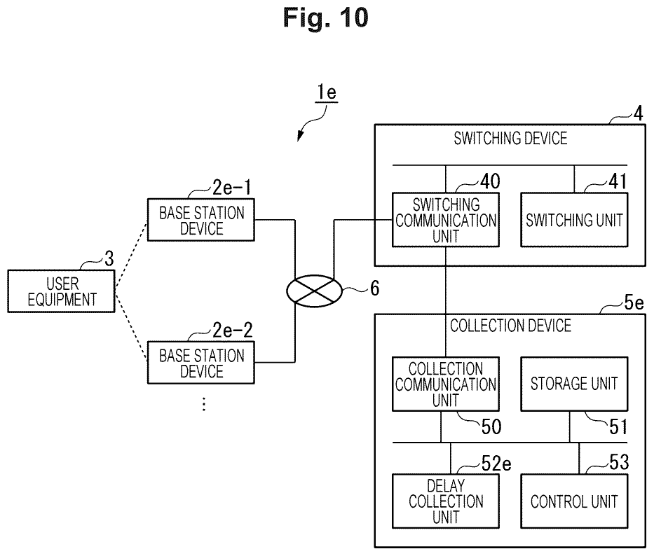

FIG. 10 illustrates a configuration example of a communication system le in the fourth embodiment. The communication system le includes a plurality of base station devices 2e, user equipment 3, a switching device 4, a collection device 5e, and a communication line 6. The switching device 4 includes a switching communication unit 40 and a switching unit 41. The collection device 5e includes a collection communication unit 50, a storage unit 51, a delay collection unit 52e, and a control unit 53. In the fourth embodiment, a method in which the base station device 2e notifies the collection device 5e of switching of a communication path is a pull notification method.

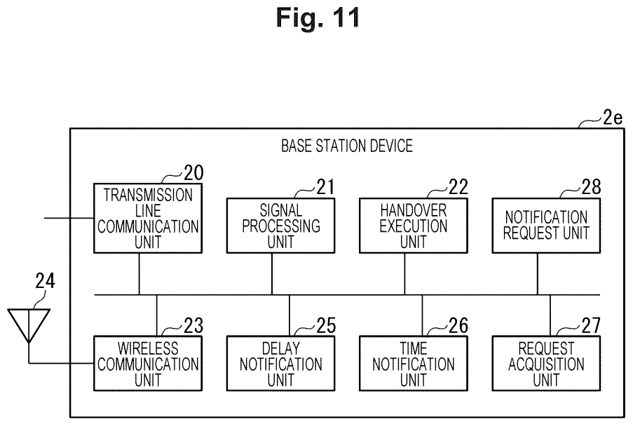

FIG. 11 illustrates a configuration example of the base station device 2e in the fourth embodiment. The base station device 2e includes a transmission line communication unit 20, a signal processing unit 21, a handover execution unit 22, a wireless communication unit 23, an antenna 24, a delay notification unit 25, a time notification unit 26, a request acquisition unit 27, and a notification request unit 28.

The delay collection unit 52e transmits a signal to request notification of delay information of a switched communication path to a source base station device 2e-1 at a predetermined cycle. The base station device 2e-1 acquires the signal transmitted from the delay collection unit 52e at the predetermined cycle from the delay collection unit 52e. In a case where the signal to request the notification of the delay information of the switched communication path is acquired, the notification request unit 28 of the source base station device 2e-1 requests a destination base station device 2e-2 to notify the collection device 5e of the delay information. For example, the notification request unit 28 transmits the signal to request the notification of the delay information of the switched communication path to the destination base station device 2e-2.

The delay notification unit 25 of the base station device 2e-2 acquires, from the base station device 2e-1, the signal to request the notification of the delay information of the switched communication path as a notification request. When acquiring the signal to request the notification of the delay information of the switched communication path, the delay notification unit 25 transmits the delay information of the switched communication path to the delay collection unit 52e.

Next, an operation example of the communication system le will be described.

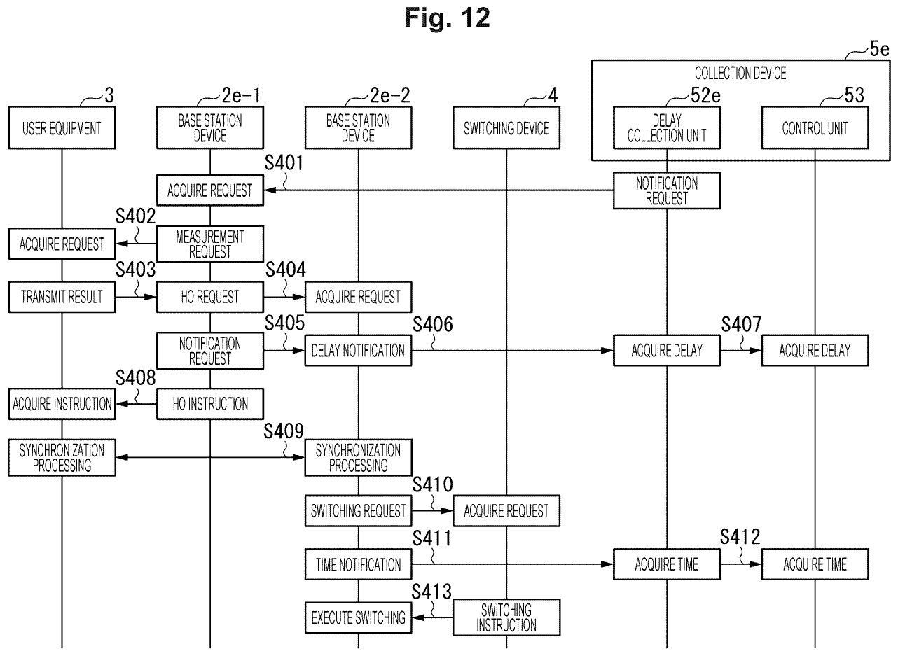

FIG. 12 is a sequence diagram showing an operation example of the communication system le in the fourth embodiment. The delay collection unit 52e transmits a signal to request notification of delay information of a switched communication path to the source base station device 2e-1 at a predetermined cycle. The base station device 2e-1 acquires the signal transmitted from the delay collection unit 52e at the predetermined cycle from the delay collection unit 52e (step S401).

Step S402 to step S404 are similar to step S302 to step S304 in FIG. 9. In a case where the signal to request the notification of the delay information of the switched communication path is acquired, the notification request unit 28 of the source base station device 2e-1 requests the destination base station device 2e-2 to notify the collection device 5e of the delay information (step S405). Step S406 to step S413 are similar to step S305 to step S312 in FIG. 9.

As described above, in a case where the signal to request the notification of the delay information of the switched communication path is acquired, the notification request unit 28 of the source base station device 2e-1 requests the destination base station device 2e-2 to notify the collection device 5e of the delay information. In a case where the signal to request the notification of the delay information of the switched communication path is acquired (in a case where notification of the delay information is requested), the delay notification unit 25 of the destination base station device 2e-2 transmits the delay information of the switched communication path to the delay collection unit 52e.

Therefore, even in a case where the communication path to the user equipment that wirelessly communicates with the base station device is switched, it is possible to suppress deterioration of the control performance of the user equipment.

### Hardware Configuration Example

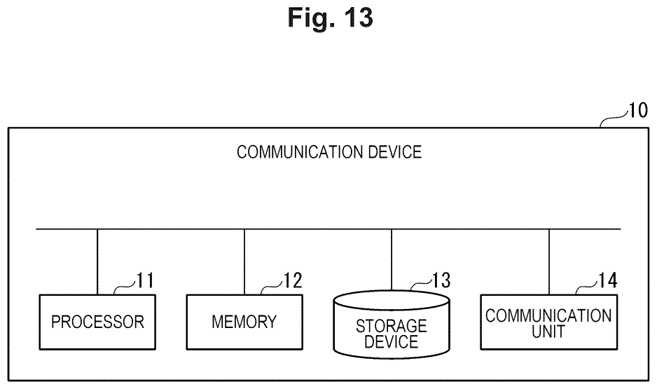

FIG. 13 illustrates a hardware configuration example of the communication device in each embodiment. A communication device 10 corresponds to at least one of the user equipment, the base station device, the switching device, and the collection device in each embodiment. The communication device 10 includes a processor 11. The processor 11 such as a central processing unit (CPU) executes a program stored in a storage device 13 and a memory 12 including a nonvolatile recording medium (non-transitory recording medium) and thus is implemented as software. The program may be recorded in a computer-readable non-transitory recording medium. The computer-readable non-transitory recording medium is a non-transitory recording medium such as a portable medium including, for example, a flexible disk, a magneto-optical disk, a ROM (read only memory), and a CD-ROM (compact disc read only memory) or a storage device such as a hard disk built in a computer system, A communication unit 14 executes predetermined communication processing.

At least some of functional units of the communication device 10 may be an analog circuit or a digital circuit. A signal processing device may be implemented by using hardware including an electronic circuit (or circuitry) using, for example, an LSI (large scale integrated circuit), an ASIC (application specific integrated circuit), a PLD (programmable logic device), and an FPGA (field programmable gate array).

Although the embodiments of the present invention have been described in detail with reference to the drawings, specific configurations are not limited to the embodiments and include design and the like within the gist of the present invention, The embodiments may be combined. The embodiments and modification examples may be combined.

### INDUSTRIAL APPLICABILITY

The present invention is applicable to a wireless communication system.

### REFERENCE SIGNS LIST

1a, 1b, 1c, 1d, le Communication system
2a, 2b, 2c, 2d, 2e Base station device
3 User equipment
4 Switching device
5a, 5b, 5c, 5d, 5e Collection device
6 Communication line
7 Core network
10 Communication device
11 Processor
12 Memory
13 Storage device
14 Communication unit
20 Transmission line communication unit
21 Signal processing unit
22 Handover execution unit
23 Wireless communication unit
24 Antenna
25 Delay notification unit
26 Time notification unit
27 Request acquisition unit
28 Notification request unit
40 Switching communication unit
41 Switching unit
50 Collection communication unit
51 Storage unit
52a, 52b, 52c, 52d, 52e Delay collection unit
53 Control unit

1. A communication device comprising:
a processor; and
a storage medium having computer program instructions stored thereon, when executed by the processor, perform to:
before a communication path to user equipment is switched, executes processing of issuing information of the switched communication path or delay information of the communication path and information regarding a switching time of the communication path; and
requests a predetermined switching device to switch the communication path at the switching time.

2. (canceled)

3. A communication system comprising:
a processor; and
a storage medium having computer program instructions stored thereon, when executed by the processor, perform to:
before a communication path to user equipment is switched, executes processing of issuing information of the switched communication path or delay information of the communication path and information regarding a switching time of the communication path;
requests a predetermined switching device to switch the communication path at the switching time;
before the communication path to the user equipment is switched, collects the information of the switched communication path or the delay information of the communication path and the information regarding the switching time of the communication path; and
after the switching time, controls the user equipment by using the delay information associated with the issued information of the communication path or the issued delay information.

4. A notification method executed by a communication device, the notification method comprising:
a step of, before a communication path to user equipment is switched, executing processing of issuing information of the switched communication path or delay information of the communication path and information regarding a switching time of the communication path; and
a step of requesting a predetermined switching device to switch the communication path at the switching time.

5. The method of claim 4 further comprises:
a step of, before a communication path to user equipment is switched, collecting information of the switched communication path or delay information of the communication path and information regarding a switching time of the communication path; and
a step of, after the switching time, controlling the user equipment by using the delay information associated with the issued information of the communication path or the issued delay information.

6. (canceled)

7. (canceled)
